(19) United States
(12) Patent Application Publication
(10) Pub. No.: US 2011/0136610 A1
(43) Pub. Date: Jun. 9, 2011

(54) ACTUATOR FOR OPERATING A DIFFERENTIAL LOCK

(76) Inventors: Roberto Gianone, Barengo (NO) (IT); Chiara Cesari, Novara (IT); Marco Bassi, Novate Milanese (Mi) (IT)

(21) Appl. No.: 12/959,863

(22) Filed: Dec. 3, 2010

(30) Foreign Application Priority Data
Dec. 4, 2009 (GB) 0921263.0

(51) Int. Cl. F16H 48/30

(52) U.S. Cl. 475/150

(57) ABSTRACT

An actuator for operating a differential lock includes a chassis, a first motor mounted on the chassis and including a first motor pinion, a second motor mounted on the chassis and including a second motor pinion, and a ring gear rotatably mounted on the chassis about a ring gear axis and having a ring gear thread defined about the ring gear axis. The actuator includes an actuator element having an actuator element thread in engagement with the ring gear thread and having a feature for preventing rotation of the actuator element thread, the first motor pinion and second motor pinion being operable to drive the ring gear.

### REFERENCE TO RELATED APPLICATION

This application claims priority to United Kingdom Application No. GB 0921263.0 filed Dec. 4, 2009.

### BACKGROUND OF THE INVENTION

The present invention relates to actuators, in particular, actuators for operating a differential lock of a land vehicle, such as a truck or car. The present invention also relates to a method of operating a differential.

Differentials are known in rear axles of trucks. Their purpose is to allow the right and left hand truck wheels to turn at different speeds while still transmitting power to those wheels. Thus, when a truck negotiates a bend, the inside wheel will travel slower than the outside wheel, and the differential allows for this difference in rotational speed while still maintaining power to both wheels. GB1130112 shows an example of a differential mechanism. A drive pinion rotates a crown wheel gear. The crown wheel gear is attached to the differential casing. The casing drives intermediate gears, which in turn drive right and left hand differential gears, which are rotatably coupled to right and left hand drive shafts. The differential can be considered to be a three shaft system. In this case, all three shafts rotate about the same axis, the first shaft being defined by the differential casing, the second shaft being defined by the left hand drive shaft, and the third shaft being defined by the right hand drive shaft. In this case, a series of clutch plates are engageable so as to rotatably couple the differential casing to the left hand drive shaft, thereby locking the differential. The clutch is engaged by an electric motor operating a lever.

However, the motor is bulky, and the operating mechanism is also bulky. For the differential lock to operate, pressure must be continuously applied to the clutch plates, and hence the motor must be continually powered when the differential lock is engaged. This utilizes a significant amount of energy and may cause the motor to overheat in adverse conditions.

### SUMMARY OF THE INVENTION

An object of the present invention is to provide an improved form of differential lock actuator. Another object of the present invention is to provide a differential lock actuator which uses less energy.

An actuator includes a chassis, a first motor mounted on the chassis and including a first motor pinion, a second motor mounted on the chassis and including a second motor pinion, and a ring gear rotatably mounted on the chassis about a ring gear axis and having a ring gear thread defined about the ring gear axis. The actuator includes an actuator element having an actuator element thread in engagement with the ring gear thread and having a feature for preventing rotation of the actuator element thread, the first motor pinion and second motor pinion being operable to drive the ring gear.

Utilizing two motors to drive a single ring gear provides for a compact arrangement. The actuator may be used to operate a differential lock. The actuator may be used to change between two speeds on a two speed axle.

In one embodiment, the ring gear has a first axial side and a second axial side, and the first motor and the second motor are positioned on the first axial side, and the actuator element is positioned on the first axial side. Arranging both motors and the actuator element on the same side of the ring gear provides for a compact arrangement.

In one embodiment, the first motor is positioned substantially diametrically opposite to the second motor when considering the ring gear axis. Positioning the motors diametrically opposite to each other when considering the ring gear axis provides a compact arrangement.

In one embodiment, the first motor pinion engages a first motor intermediate gear set, the first motor intermediate gear set engaging the ring gear, and the second motor pinion engages a second motor intermediate gear set, the second motor intermediate gear set engaging the ring gear.

Arranging the intermediate gear sets opposite to each other ensures that forces on the ring gear are balanced and do not tend to tip the ring gear.

In one embodiment, the actuator element has a first part having the actuator element thread, a second part axially moveable relative to the first part, and a resilient element to allow axial movement of the first part relative to the second part. Such an arrangement allows for relative axial movement between the first part and the second part if, during an attempt to engage the differential lock, clashing of differential lock gear teeth occurs.

In one embodiment the first part is rotationally fast with the second part. By providing the first part rotationally fast with a second part, when the second part is prevented from rotating (for example, by engaging the chassis), the first part will be prevented from rotating.

In one embodiment, a chassis defines a housing, the housing receiving at least a part of one or more of the first motor, the second motor, the first motor pinion, the second motor pinion, the first motor intermediate gear set, the second motor intermediate gear set, the ring gear, the first part, the second part, the resilient element, a resilient feature and a feature for detecting when the actuator is in the actuator position.

The housing can be used to protect the various components contained within from the harsh exterior environment. In particular, both motors can be contained within a housing, and hence electrical connectors to the motors can be protected by the housing.

In one embodiment, the various gears of the system can be contained within the housing. Thus, the first motor pinion, the second motor pinion, and the ring gear may be contained within the housing. In embodiments which include a first motor intermediate gear set and a second motor intermediate gear set, these gear sets can also be included within the housing.

In one embodiment, the feature for detecting when the actuator is in the actuated position can also be included within the housing. In particular, where such feature is a switch or the like, the housing can act to protect the switch from the exterior environment. Furthermore, by providing the switch or the like in the housing allows the housing to protect both the switch and other components, while still being able to detect whether or not the actuator is in the actuated position, and hence being able to detect whether or not an associated differential lock is in a locking position.

In one embodiment, the first motor pinion is in permanent driving engagement with the ring gear, and the second motor pinion is in permanent driving engagement with the ring gear. In one embodiment, the ring gear axis is a fixed axis, i.e., the ring gear only rotates about the ring gear axis and does not rotate about any other axis. In one embodiment, the first motor is operable to drive the ring gear by a fixed gear ratio. In one embodiment, the second motor is operable to drive the ring gear by a fixed gear ratio. In one embodiment, when the first motor is operable to drive the ring gear by a fixed first gear ratio and when the second motor is operable to drive the ring gear by a fixed second gear ratio, the fixed first gear ratio may be the same as the fixed second gear ratio. Under such circumstances, the motors will operate at the same speed when driving the ring gear. In one embodiment, the two motors are identical motors. In one embodiment, there are only two motors.

As will be appreciated, while collectively the two motors will be powerful enough to create a force large enough to operate an associated differential lock, one motor alone (e.g., in the event of a failure of the second motor) may not be powerful enough to create a force large enough to operate the associated differential lock. Under such circumstances, the actuator does not need any redundant motors, and as such the two motors can be less powerful, and hence smaller and more compact than if one of the motors was a redundant motor.

A method of operating a differential includes the steps of providing a differential having a first shaft having a first array of gear teeth, a second shaft and a third shaft, providing a differential lock gear secured axially movably but rotationally fast with the second shaft, the differential lock having a second array of gear teeth for selective engagement with the first array of gear teeth so as to prevent relative rotation of the first and second shafts. The method further includes the steps of providing a biased feature to selectively bias the teeth out of engagement with each other, powering an electrical actuator so as to engage the teeth, then intermittently powering the electrical actuator so as to maintain engagement of the teeth, then cutting power to the electric actuator so as to allow the teeth to disengage by action of the biased feature.

Intermittently powering the electric actuator when the teeth are engaged reduces the power consumption required to keep the differential lock engaged.

Where the electric actuator includes a first motor and a second motor, the step of intermittently powering the electric actuator can be carried out by intermittently powering just one of the first motor and the second motor. In this manner, the power consumption required to keep the differential lock engaged is reduced.

A method of operating a differential includes the steps of providing a differential having a first shaft having a first array of gear teeth, a second shaft and a third shaft, and providing a differential lock secured axially movably but rotationally fast with the second shaft, the differential lock having a second array of gear teeth for selective engagement with the first array of gear teeth so as to prevent relative rotation of the first and second shafts. The method including the steps of 1) starting with the first array of gear teeth disengaged from the second array of gear teeth, 2) powering an electric actuator as to attempt to engage the first and second arrays of gear teeth, 3) determining if the first and second arrays of gear teeth have engaged with each other within a predetermined time, 4) if no such engagement occurs within said predetermined time cutting power to the electric actuator, and 5) repeating steps 2 to 4 until engagement occurs or until engagement is no longer required.

Such a method is able to detect when a differential lock fails to properly engage and then causes the electric actuator to return to a rest position and then retry, as many times as necessary.

### BRIEF DESCRIPTION OF THE DRAWINGS

The invention will now be described, by way of example only, with reference to the accompanying drawings in which:

FIG. 1 is a cross-section view of an actuator according to the present invention,

FIG. 2 is a cross-section view of some of the components of FIG. 1,

FIGS. 3, 4, 5A and 5B are views of some of the components of FIG. 1,

FIG. 6 shows a schematic view of the actuator of FIG. 1 mounted on an associated axle, and

FIGS. 7 and 8 show graphs of motor voltage and actuator position during typical use.

### DETAILED DESCRIPTION OF THE PREFERRED EMBODIMENT

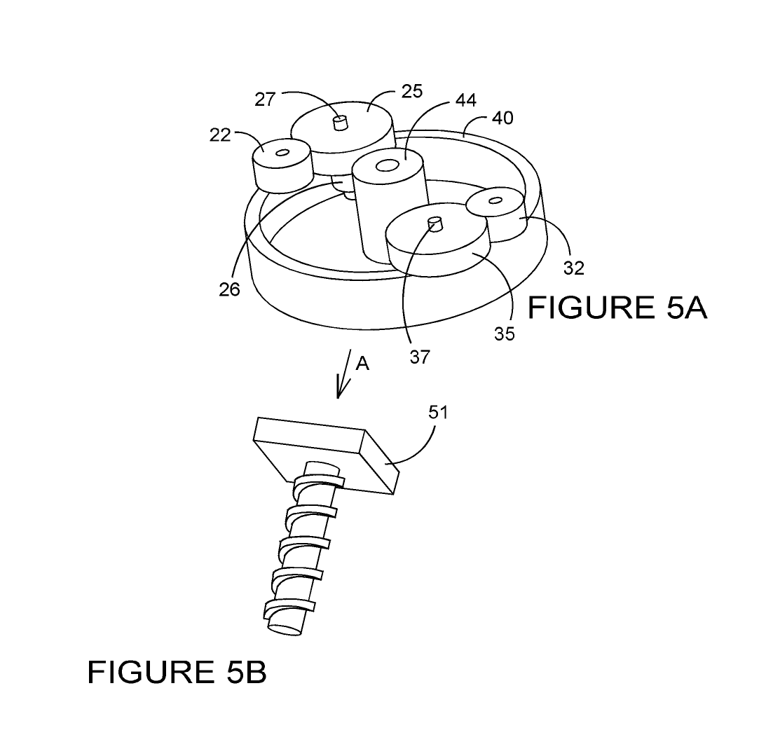

With reference to the Figures there is shown an actuator 10 having a housing 12. The housing 12 is a two part housing having a first part 14 and a second part 15. Contained within the housing 12 is a first motor 20 (in this example, an electric motor) and a second motor 30 (in this example, an electric motor). The first motor 20 selectively drives a first motor pinion 22, and the second motor selectively drives a second motor pinion 32. A first motor intermediate gear set 24 includes a first larger gear 25 and a first smaller gear 26. A second motor intermediate gear set 34 includes a second larger gear 35 and a second smaller gear 36. A ring gear 40 (shown in FIG. 5A) includes an annulus 41 having an array of gear teeth 42 (shown schematically) facing radially inwardly. The annulus 41 is connected by a flange 43 to a boss 44. The boss 44 has a cylindrical outer surface 45 and a threaded central hole 46. The actuator 10 also includes an actuator element 50. In this case, actuator element 50 comprises three components, namely a bolt 51, a spring 52 and an outer sheath 53.

The bolt 51 (as shown in FIG. 5B) includes a male thread 60 for engaging with a female thread in the threaded central hole 46. The bolt 51 has a bolt head 61 which is square when viewed in the direction of an arrow A. The outer sheath 53 has a generally cylindrical outer surface 65 having a lug 66 at one end, the lug 66 including a hole 67. The outer sheath 53 also includes an axially orientated blind hole 68 which is square in cross-section. The square cross-section shape of the blind hole 68 mates with the square bolt head 61 to prevent the latter from rotating relative to the outer sheath 53 in use. The square cross-section of the blind hole 68 is large enough to accommodate the cylindrical outer surface 45 of the boss 44. Positioned within the blind hole 68 is the spring 52. The spring 52 is positioned between the bolt head 61 and an end 69 of the blind hole 68. The outer sheath 53 includes a flange 70 having a first arm 71 and a second arm 72 at an end of the outer sheath 53 remote from the end 69.

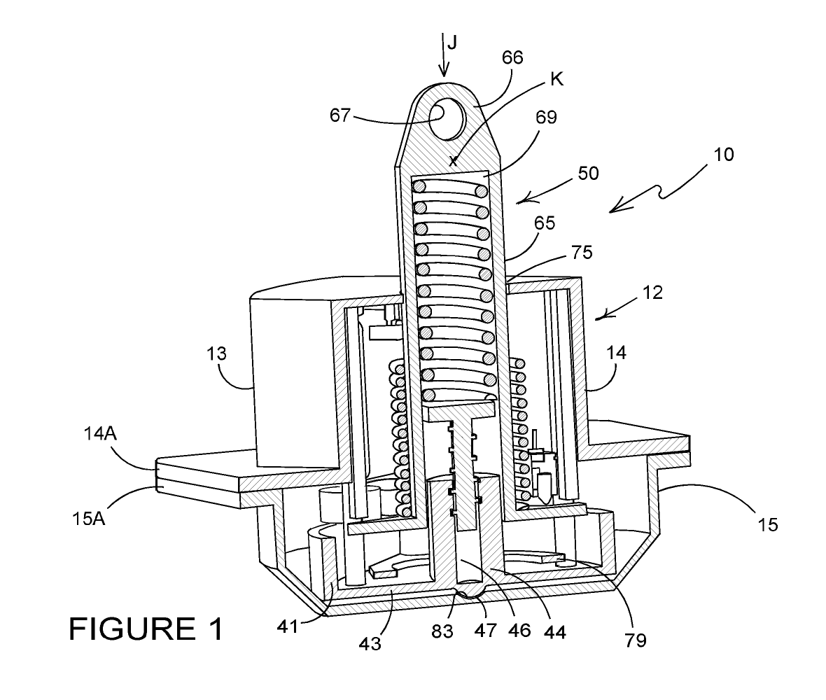

As is best seen in FIG. 1, the first part 14 of the housing 12 is generally top hat shaped and includes a hole 75 through which the outer sheath 53 projects. The second part 15 of the housing 12 is also generally top hat shaped. The first part 14 is secured to the second part 15 via flanges 14A and 15A. The first part 14 includes axially projecting pins 76 and 77 which project into the recess formed by the second part 15. The pins 76 and 77 support a bearing plate 79.

A return spring 80 (only the lower part of which is shown) engages the flange 70 of the outer sheath 53 at one end and engages the inner surface of the first part 14 of the housing 12 at an opposite end. An electric switch 81 is positioned above the first arm 71.

The first motor 20 is rotatable about an axis B. The second motor 30 is rotatable about an axis C. The ring gear 40 is rotatable about an axis D. The first motor intermediate gear set 24 is rotatable about an axis E. The second motor intermediate gear set 34 is rotatable about an axis F. The actuator element 50 has a longitudinal axis defined by the axis D. Axis B and axis C are parallel. Axis B and axis D are parallel. Axis C and axis D are parallel. Axis B and axis E are parallel. Axis C and axis F are parallel. Axis B is offset from axis D. Axis C is offset from axis D.

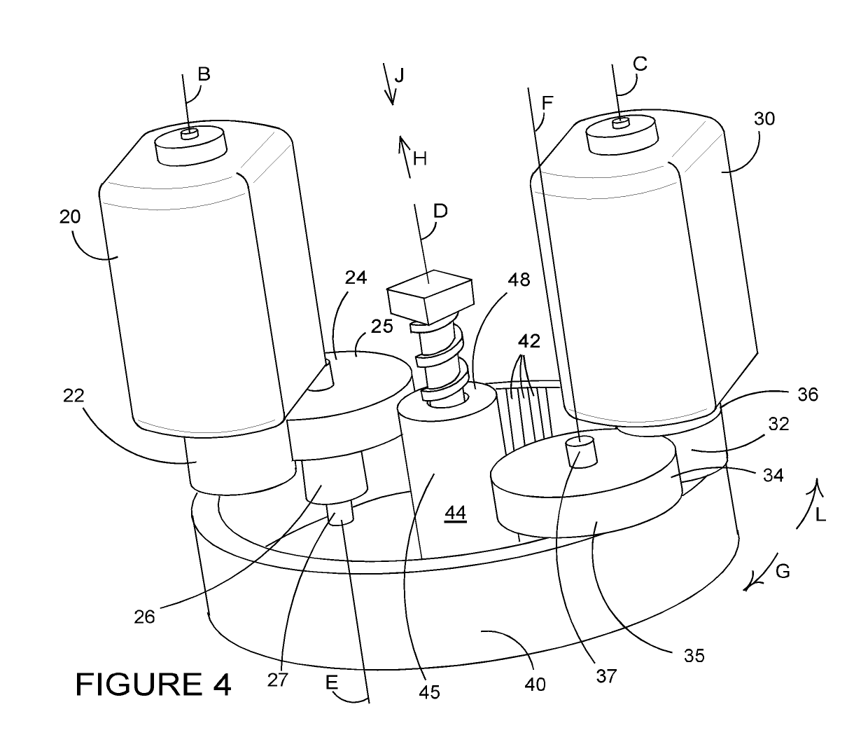

The housing 12 defines a chassis 13 of the actuator. The first motor 20 and the second motor 30 are mounted on the chassis 13. The chassis 13 includes the bearing plate 79, which is secured to the pins 76 and 77. The bearing plate 79 includes holes for receiving bosses of the first motor intermediate gear set 24 and the second motor intermediate gear set 34 (see in particular the boss 27 on FIG. 4). The first part 14 of the housing 12 also includes recesses for receiving bosses of the first motor intermediate gear set 24 and the second motor intermediate gear set 34 (see in particular the boss 37). As such, the first motor intermediate gear set 24 is rotatably mounted on the chassis 13 as is the second motor intermediate gear set 34. A projection 47 on a side of the flange 43 of the ring gear 40 opposite to the boss 44 engages a recess 83 in the second part 15 of the housing 12, thereby providing a bearing.

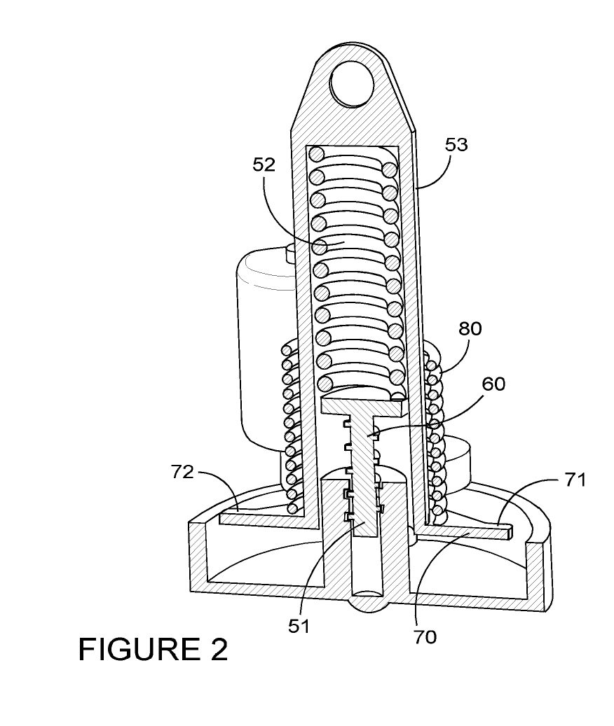

Operation of the actuator 10 is as follows. In summary, FIGS. 1 to 4 show the actuator 10 in an actuated position. The motors have driven the ring gear 40 in the direction of an arrow G, causing the bolt 51 to move in the direction of an arrow H to the actuated position against the bias of the return spring 80.

Once power to the motors is cut for a significant amount of time, the return spring 80 biases the actuator element 50 in the direction of an arrow J to a rest position where the center of the hole 67 has moved to a point K.

In more detail, in the rest position, as mentioned above, the center of the hole 67 is positioned at the point K, and hence the bolt head 61 is positioned near the end 48 of the boss 44. The flange 70 is positioned near the bearing plate 79. The flange 70 is positioned remote from the electric switch 81. The pins 76 and 77 prevent rotation of the outer sheath 53 about the axis D by engagement with the adjacent first arm 71 and the second arm 72. Because the outer sheath 53 is prevented from rotating about the axis D, then, by virtue of the square cross-section of the bolt head 61 engaging the square cross-section bore of the outer sheath 53, the bolt 51 is also prevented from rotating about the axis D.

Starting from the rest position, both the motors 20 and 30 are simultaneously powered to rotate the first motor pinion 22 and the second motor pinion 32. The motor pinions 22 and 32 in turn rotate their associated intermediate gear sets 24 and 34. The intermediate gear sets 24 and 34 in turn cause the ring gear 40 to rotate in the direction of the arrow G. Due to the female thread in the threaded central hole 46 of the boss 44 and the male thread 60 on the bolt 51, and by virtue of the fact that the bolt 51 is prevented from rotating about the axis D, rotation of the ring gear 40 in the direction of the arrow G causes the bolt 51 to move linearly in the direction of the arrow H. Movement in the direction of the arrow H of the bolt 51, and in particular the bolt head 61, causes the spring 52 to act on end 69 and thereby move the actuator element 50 from the rest position to the actuated position as shown in FIGS. 1 to 4.

Once power to the motor is cut for a significant amount of time, the return spring 80 biases the actuator elements to the rest position, thereby causing the ring gear 40 to rotate in the direction of an arrow L (opposite to the direction arrow G), which in turn causes the motors 20 and 30 to be back driven via the intermediate gear set 24 and 34 and the motor pinions 22 and 32.

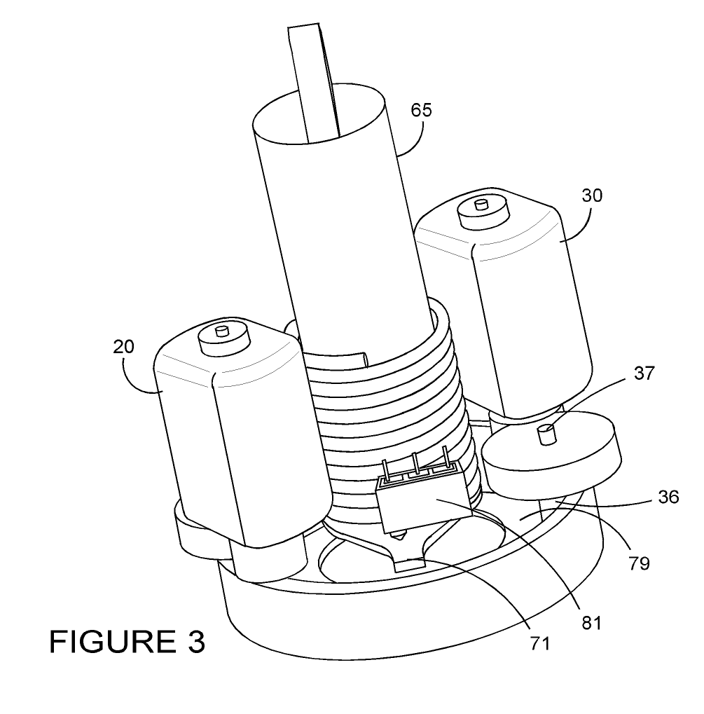

As shown in the FIG. 3, the electric switch 81 has detected that the actuator element 50, in particular the outer sheath 53 is in its actuated position. When the outer sheath 53 is in its rest position, the flange 70 is remote from the electric switch 81.

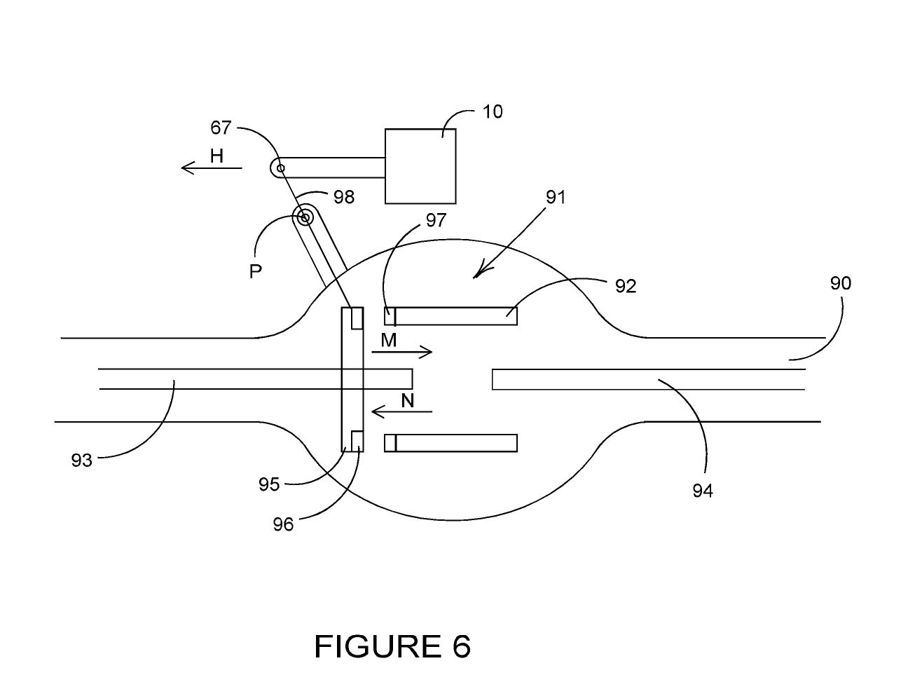

FIG. 6 shows the actuator 10 installed on a rear axle 90 (only part of which is shown) of a vehicle. The rear axle 90 includes a differential 91 having a differential casing 92, a first driven shaft 93, and a second driven shaft 94. A differential lock gear 95 is axially slidable but rotationally fast with the first driven shaft 93 and includes an array of the teeth 96 for selectively engaging an array of gear teeth 97 secured rotationally fast to the differential casing 92. To engage the differential lock, the differential lock gear 95 is moved in the direction of an arrow M so that the gear teeth 96 engage the gear teeth 97, thereby locking the differential casing 92 to the first driven shaft 93. In order to disengage the differential lock, the differential lock gear 95 is moved in the direction of an arrow N back to the position shown in FIG. 6 wherein the gear teeth 96 are disengaged from the gear teeth 97. The rear axle 90, the differential 91, the differential casing 92, the first driven shaft 93, the second driven shaft 94, the differential lock gear 95, the gear teeth 96 and the gear teeth 97 are all known.

A lever 98 is pivotable about an axis P (defined by a lug on the axle housing) via the actuator 10. Counter-clockwise rotation of the lever 98 about an axis P causes engagement of the differential lock, and subsequent clockwise rotation of the lever 98 about the axis P causes disengagement of the differential lock. The form locking engagement between the gear teeth 96 and the gear teeth 97 can be contrasted with the clutch plates of the differential lock of GB1130112.

The engaging parts of the gear teeth 96 and 97 can be orientated on a plane passing through the rotational axis of the first driven shaft 93. Alternatively, the gear teeth 96 and 97 can be “undercut” so that, once engaged, the gear teeth 96 and 97 tend to stay engaged as torque is applied. Undercut gears, and parallel gears, have the advantage that, once the gear teeth 96 and 97 are engaged, then they will tend to hold themselves in engagement, and the actuator force provided by the motors 20 and 30 can be reduced.

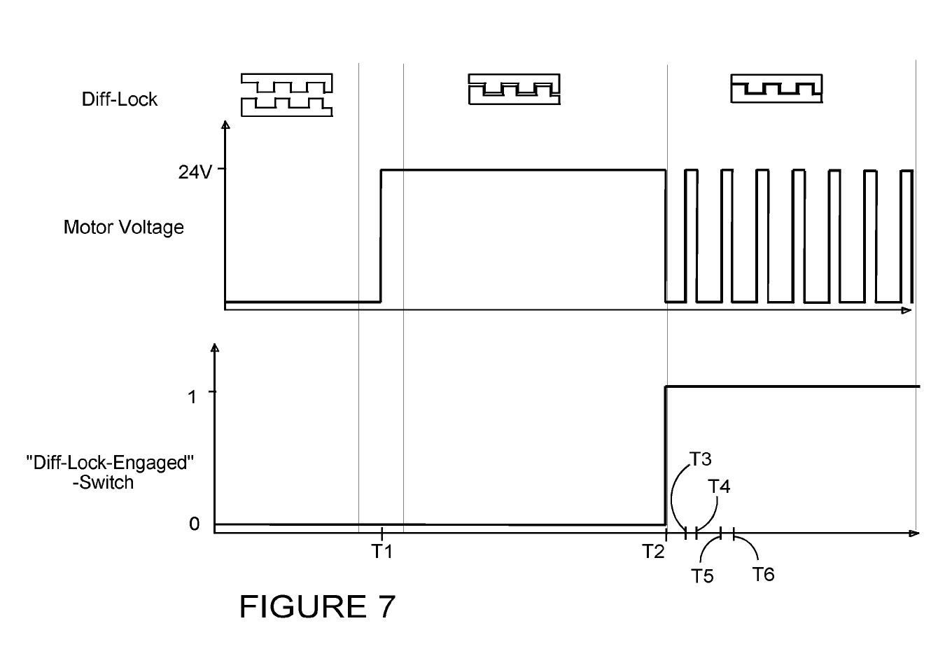

FIG. 7 shows the sequence of events occurring when the differential lock is engaged. At time T0, the differential lock is disengaged, and hence no power is being fed to the motors 20 and 30. At time T1, the driver requests locking of the differential, typically by operating a switch or the like, and power is fed to both motors 20 and 30 to move the actuator element 50 in the direction of the arrow H, causing the differential lock gear 95 to move in the direction of the arrow M. At time T2, the gear teeth 96 are engaged with the gear teeth 97, and the flange 70 has engaged the electric switch 81, thereby signalling that the differential lock is engaged. Because the gear teeth 97 and 96 are either parallel or undercut, then the differential lock tends to stay engaged, and power to the motor can be cut between the time T2 and the time T3. However because time (T3−T2) is so short, the gear teeth 96 and 97 do not have an opportunity to disengage. Between the time T3 and the time T4, a voltage pulse is applied to the motors 20 and 30 to ensure the gear teeth 96 and 97 remain in engagement. Between the time T4 and the time T5, no voltage is applied to the motors 20 and 30. Between the time T5 and the time T6, a voltage pulse is applied to the motors 20 and 30 for a short time to ensure the gear teeth 96 and 97 remain engaged. This pulsing of voltage continues until such time as is required to disengage the differential lock, whereupon all power to the motors 20 and 30 is cut and remains cut. The return spring 80 will then disengage the differential lock and return the actuator 10 to its rest position. Note that for explanation purposes, the gear teeth 96 and 97 have been described as being parallel or undercut. None parallel none undercut teeth could equally be used with applying pulsing voltages to the motor, though under such circumstances, the pulse of voltage may have to be applied for a longer period, and the time period where no voltage is applied may be required to be shorter, depending upon the particular circumstances.

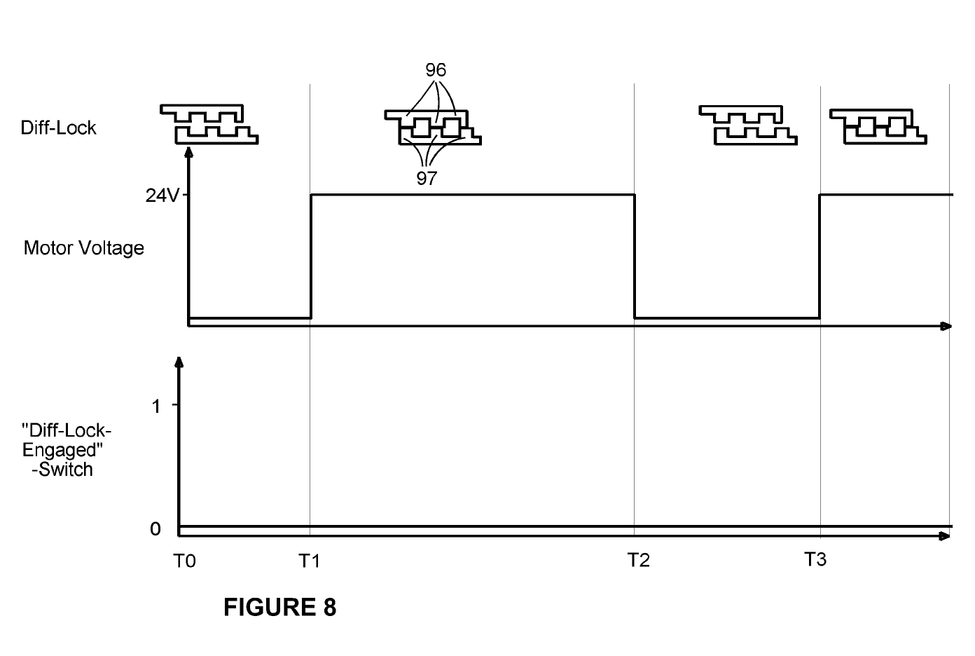

With reference to FIG. 8, there is shown the sequence of events that occurs when the differential lock is engaged, but when the gear teeth 96 “clash” with the gear teeth 97. Thus, at time T0, no voltage is applied to the motor, and the differential lock is disengaged. At time T1, voltage is applied to the motor to engage the differential lock. However, unlike the FIG. 8 scenario, the gear teeth 96 and 97 do not properly interengage, rather the ends of the gear teeth 96 and 97 clash with each other as shown diagrammatically in FIG. 8. As will be appreciated, under these circumstances, while the bolt 51 has moved to its actuated position as shown in FIGS. 1 to 4, the outer sheath 53 is prevented from moving to its actuated position by virtue of the clashing gear teeth 96 and 97. Under these circumstances, the spring 52 is compressed. After a predetermined time (T2−T1), an ECU recognises a failure to engage the differential lock (since the electric switch 81 has not been operated by the flange 70), and power to the motors 20 and 30 is cut. After a period of time (T3−T2), the ECU again applies a voltage to the motors 20 and 30, endeavouring to reengage the differential lock. As can be seen in FIG. 8, a clash of gear teeth 96 and 97 has again occurred after the time T3 and hence after the predetermined amount of time, the ECU will again cut the power to the motor. The sequence will repeat itself until such time as the differential lock correctly engages, or until such time as it is no longer required to engage the differential lock.

The foregoing description is only exemplary of the principles of the invention. Many modifications and variations are possible in light of the above teachings. It is, therefore, to be understood that within the scope of the appended claims, the invention may be practiced otherwise than using the example embodiments, which have been specifically described. For that reason the following claims should be studied to determine the true scope and content of this invention.

What is claimed is:

1. An actuator for operating a differential lock, the actuator comprising:
a chassis;
a first motor mounted on the chassis and including a first motor pinion;
a second motor mounted on the chassis and including a second motor pinion;
a ring gear rotatably mounted on the chassis about a ring gear axis and having a ring gear thread defined about the ring gear axis; and
an actuator element having an actuator element thread in engagement with the ring gear thread and having a feature for preventing rotation of the actuator element thread, wherein the first motor pinion and second motor pinion are operable to drive the ring gear.

2. The actuator as defined in claim 1 wherein the ring gear has a first axial side and a second axial side and the first motor and the second motor are positioned on the first axial side and the actuator element is positioned on the first axial side.

3. The actuator as defined in claim 1 wherein the first motor is positioned substantially diametrically opposite to the second motor relative to the ring gear axis.

4. The actuator as defined in claim 1 wherein the ring gear has inwardly facing ring gear teeth.

5. The actuator as defined in claim 1 wherein the first motor pinion engages a first motor intermediate gear set, the first motor intermediate gear set engages the ring gear, the second motor pinion engages a second motor intermediate gear set, and the second motor intermediate gear set engages the ring gear.

6. The actuator as defined in claim 5 wherein the first motor intermediate gear set is positioned substantially diametrically opposite to the second motor intermediate gear set relative to the ring gear axis.

7. The actuator as defined in claim 1 wherein the actuator element has a first part having the actuator element thread, a second part axially moveable relative to the first part and a resilient element to allow axial movement of the first part relative to the second part.

8. The actuator as defined in claim 7 wherein the first part is rotationally fast with the second part.

9. The actuator as defined in claim 8 wherein the second part engages the chassis to prevent rotation of the second part relative to the chassis.

10. The actuator as defined in claim 7 wherein the first part is received at least partially within the second part.

11. The actuator as defined in claim 1 wherein a resilient feature biases the actuator element to a rest position.

12. The actuator as defined in claim 11 wherein the actuator element has a first part having the actuator element thread, a second part axially moveable relative to the first part, a resilient element to allow axial movement of the first part relative to the second part, wherein the first part is rotationally fast with the second part, and the resilient features engages the second part to bias the actuator element to the rest position.

13. The actuator as defined in claim 1 including a feature for detecting when the actuator is in an actuated position.

14. The actuator as defined in claim 5 wherein the chassis defines a housing for receiving at least a part of one or more of the first motor, the second motor, the first motor pinion, the second motor pinion, the first motor intermediate gear set, the second motor intermediate gear set, the ring gear, a first part having the actuator element thread, a second part axially moveable relative to the first part, a resilient element to allow axial movement of the first part relative to the second part, a resilient feature to bias the actuator element to a rest position, and a feature for detecting when the actuator is in the actuated position.

15. A method of operating a differential comprising the steps of:
providing a differential including a first shaft having a first array of gear teeth, a second shaft, and a third shaft;
providing a differential lock gear secured axially movably but rotationally fast with the second shaft, the differential lock gear having a second array of gear teeth for selective engagement with the first array of gear teeth to prevent relative rotation of the first shaft and the second shaft;
providing a biased feature to selectively bias the gear teeth out of engagement with each other;
powering an electrical actuator to engage the gear teeth;
then intermittently powering the electrical actuator to maintain engagement of the gear teeth; and
then cutting power to the electric actuator to allow the gear teeth to disengage by action of the biased feature.

16. The method of operating a differential as defined in claim 15 wherein the electric actuator includes a chassis, a first motor mounted on the chassis and including a first motor pinion, a second motor mounted on the chassis and including a second motor pinion, a ring gear rotatably mounted on the chassis about a ring gear axis and having a ring gear thread defined about the ring gear axis, and an actuator element having an actuator element thread in engagement with the ring gear thread and having a feature for preventing rotation of the actuator element thread, wherein the first motor pinion and second motor pinion are operable to drive the ring gear.

17. The method of operating a differential as defined in claim 16 wherein the step of intermittently powering the electric actuator is carried out by intermittently powering just one of the first motor and the second motor.

18. A method of operating a differential comprising the steps of:
providing a differential having a first shaft having a first array of gear teeth, a second shaft, and a third shaft;
providing a differential lock secured axially movably but rotationally fast with the second shaft, the differential lock having a second array of gear teeth for selective engagement with the first array of gear teeth to prevent relative rotation of the first shaft and the second shaft;
disengaging the first array of gear teeth from the second array of gear teeth;
powering an electric actuator to attempt to engage the first array of gear teeth and the second array of gear teeth;
determining if the first array of gear teeth and the second array of gear teeth have engaged with each other within a predetermined time;
cutting power to the electric actuator if no such engagement occurs within the predetermined time; and
repeating the step of powering the electric actuator to the step of cutting power to the electric actuator until engagement of the gear teeth occurs or until engagement of the gear teeth is no longer required.

19. The method of operating a differential as defined in claim 16 wherein the electric actuator includes a chassis, a first motor mounted on the chassis and including a first motor pinion, a second motor mounted on the chassis and including a second motor pinion, a ring gear rotatably mounted on the chassis about a ring gear axis and having a ring gear thread defined about the ring gear axis, and an actuator element having an actuator element thread in engagement with the ring gear thread and having a feature for preventing rotation of the actuator element thread, wherein the first motor pinion and second motor pinion are operable to drive the ring gear.
